(19) United States
(12) Patent Application Publication
(10) Pub. No.: US 2004/0105791 A1
(43) Pub. Date: Jun. 3, 2004

(54) Soot trapping filter and soot reducing device thereof

(76) Inventors: In-Gweon Lim, Kyonggi-do (KR); Jun Young Hwang, Seoul (KR)

Correspondence Address: Marshall Gerstein & Borun, Sears Tower Suite 6300, 233 South Wacker Drive, Chicago, IL, 60606-6357, US

(21) Appl. No.: 10/471,992

(22) PCT Filed: Jan. 10, 2003
(86) PCT No.: PCT/KR03/00049

(30) Foreign Application Priority Data
Jan. 12, 2002 (KR) 10-2002-0001902

(51) Int. Cl. B01D 53/34

(52) U.S. Cl. 422/168; 422/173; 422/177

(57) ABSTRACT

Soot trapping filter (100), and a soot reducing device thereof, the soot trapping filter (100) including trapping means (132) having a plurality of filter granules stacked to form a volume, for trapping soot contained in exhaust gas from a combustion apparatus at a whole volume of the trapping means, wherein the filter granules include a ratio of non-spherical filter granules higher than a predetermined ratio.

### TECHNICAL FIELD

The present invention relates to a soot trapping filter, and a soot reducing device of the same, and more particularly, to a soot trapping filter for trapping soot produced from a combustion apparatus, such as a diesel engine, and a soot reducing device thereof.

### BACKGROUND ART

The diesel engine is a high efficiency power source that has approx. 30-40% of energy saving effect in comparison to a gasoline engine of the same power. Therefore, to cope with restriction on energy and carbon dioxide, that is spreading worldwide, it is preferable the diesel engine cars are made popular. However, in order to make the diesel engine popular, it is required to solve the problem of air pollution caused by smoke discharged from exhaust gas, particularly, particles, i.e., soot, beforehand. Meanwhile, it is current trend that the restriction on exhaust gas for environmental protection is strengthened faster than a development of a low pollution diesel engine. Accordingly, rather than the development of the low pollution diesel engine, attempts are presently made mostly, in which a soot reducing device, which can reduce discharge of soot produced from the engine, is fitted to an exhaust gas passage for reducing the soot from the exhaust gas.

The most general method for reducing the soot is trapping and incinerating of the soot, inclusive of particles.

In typical related art soot trapping methods, there are a method using a honeycomb form of ceramic carrier filter, and a method using a filter fabricated by weaving, or sintering high temperature fibers, or ceramic fibers. Though the foregoing related art soot trapping filters have a good filtering capability, mechanical and thermal endurances are poor. Therefore, basically it is difficult to trap the soot contained in the car exhaust gas by using the foregoing filters.

For solving the foregoing problems, the inventor suggests a method for trapping soot employing metallic or ceramic balls, and a soot reducing device thereof (Application No. PCT/KR10/00112, and Publication No. WO 01/57370).

The PCT/KR10/00112 discloses a filter having metal/ceramic balls stacked therein. Different from related art surface filtration, the filter suggested in the PCT/KR10/00112 (hereafter called as “granule layer filter”) is designed to have a predetermined volume for trapping the soot at an entire volume. That is, the granule layer filter has the soot deposited at an interface of granules and pores of the filter in a process the gas containing soot passes through the filter.

In comparison to other related art filters, the filter suggested in the PCT/KR10/00112 has no stress caused by thermal gradient inside of the filter, and excellent endurance on a high temperature environment and mechanical vibration, and, therefore, particularly suitable to a diesel engine car for trapping soot from exhaust gas.

The present invention suggests a soot trapping filter having an improved efficiency and an improved capacity, by modifying the filter suggested in the PCT/KR10/00112, and a device using the same.

### DISCLOSURE OF INVENTION

An object of the present invention is to provide a soot trapping filter having an excellent endurance, a high filtering efficiency, and a high filtering capacity, and a soot reducing device thereof.

Another object of the present invention is to provide a soot trapping filter and a soot reducing device thereof, which can reduce a production cost.

To achieve the objects of the present invention, there is provided a soot trapping filter including trapping means having a plurality of filter granules stacked to form a volume, for trapping soot contained in exhaust gas from a combustion apparatus at a whole volume of the trapping means, wherein the filter granules include a ratio of non-spherical filter granules higher than a predetermined ratio.

Preferably, the non-spherical filter granule is polyhedral, and more preferably the non-spherical filter granule has an irregular polygonal section.

The polyhedral filter granule preferably has an average size ranging 100 μm-1500 μm, and the trapping means preferably has a thickness greater than 15 mm. The trapping means preferably has a pore ratio ranging 35%-50%.

Preferably, the polyhedral filter granule is formed of at least one combination of ceramics or metals including silicon carbide.

The filter granule preferably includes a catalyst coated thereon suitable for processing pollutant refuse other than granular material, and the filter granule preferably includes a predetermined catalyst coated thereon for accelerating oxidation of the soot trapped at the filter granule.

Preferably, the trapping means is substantially cylindrical, and an exhaust gas flow direction and a direction of the exhaust gas entering into the trapping means are substantially vertical.

The trapping means preferably includes multiple stages of granule layers. The filter granules in the multiple stages of granule layers may differ in at least one of material, shape, and size. It is desirable that the filter granules in the multiple stages of granule layers have an average size becoming gradually the smaller as it goes from a front stage granule layer to a rear stage granule layer.

In another aspect of the present invention, there is provided a soot reducing device including a filter fitted on a predetermined position of an exhaust gas passage having trapping means with a plurality of filter granules stacked to form a volume, and heating means fitted in or at an interface of the filter, for elevating a temperature of the exhaust gas introduced thereto.

The soot reducing device may further includes a diffuser in a front stage of the filter for making the exhaust gas flow uniform.

Thus, according to the soot trapping filter and the soot reducing device thereof of the present invention, the filtering efficiency and filtering capacity of the filter can be improved while the filter has an endurance, and a production cost of the filter can be reduced.

### BRIEF DESCRIPTION OF DRAWINGS

FIG. 1 illustrates a section showing a soot reducing device in accordance with a preferred embodiment of the present invention, schematically;

FIG. 2 illustrates a graph showing correlation between a total circumferential length of a regular polygon and a number of apexes thereof;

FIG. 3 illustrates a graph showing a granule size in a filter vs. a filtering efficiency of the filter;

FIG. 4 illustrates a graph showing filtering efficiency vs. filter thickness;

FIG. 5 illustrates a graph showing a granule size vs. a pressure loss; and

FIG. 6 illustrates a graph showing a filter thickness vs. a pressure loss.

### BEST MODE FOR CARRYING OUT THE INVENTION

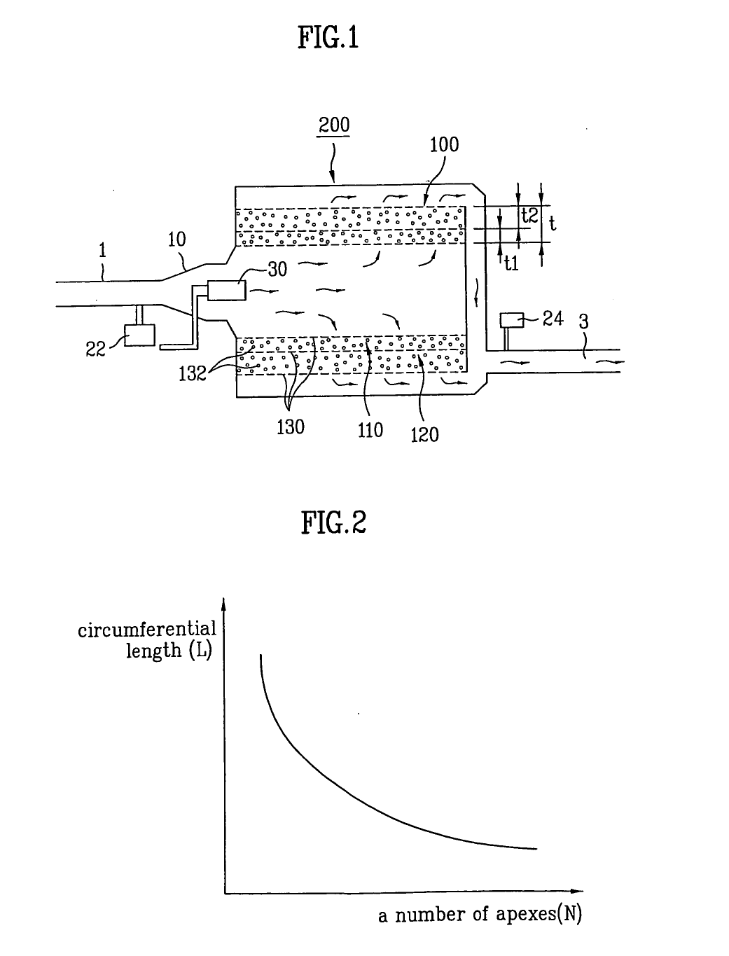

Embodiments of the soot trapping filter and a soot reducing device thereof of the present invention will be explained, with reference to the attached drawings. FIG. 1 illustrates a section showing a soot reducing device in accordance with a preferred embodiment of the present invention schematically, referring to which the soot reducing device will be explained.

There is a soot reducing device 200 fitted to a position of an exhaust gas passage 1, a passage the exhaust gas containing soot from an engine is discharged. There is a soot trapping filter 100 in a body of the soot reducing device 200, preferably having multi-stage of filters, such as a front stage filter 110 and a rear stage filter 120.

The soot trapping filter 100 includes trapping means 132 of a plurality of filter granules stacked therein, and holding means 130 for holding the filter granules in a required form. Preferably, the holding means 130 has a combination of perforated plate and mesh.

In the meantime, it is preferable that there is a reducer-expanded tube, i.e., a diffuser 10, between the exhaust gas passage 1 and the front stage filter 110 for making an exhaust gas flow uniform. It is more preferable that there is heating means 30 in front of the filter 100 or at a boundary thereof in the soot reducing device 200 for elevating a temperature of the exhaust gas in regenerating the filter. The heating means 30 may be fitted in the diffuser 10 or in the filter 100. There is no restriction on the heating means 30, i.e., the heating means 30 may be an electric heater, or other heating body.

In the meantime, it is preferable that a pressure sensor 22 is fitted in front of the diffuser 10, and a temperature sensor 24 is fitted to an end of the exhaust gas passage 1, i.e., at the outlet 3. This is because incinerating of the soot and the like trapped at the filter at fixed intervals is required for regenerating the filter, since a pore ratio is reduced as the deposited soot stuffs the pores, which increases a pressure loss of a flow. That is, a regenerating time point of the filter is determined with reference to a pressure and a temperature measured by the pressure sensor 22 and the temperature senor 24, respectively. In the middle of filtering the soot, if the pressure sensor 22 indicates a preset pressure, or the temperature sensor 24 indicates a preset temperature, the trapped soot is incinerated, to regenerate the filter. In the middle of the regenerating, the regenerating is stopped when a preset time period is passed, the pressure indicated by the pressure sensor 22 drops below a preset value, or the temperature indicated by the temperature sensor 24 rises higher than a preset value.

The soot trapping filter will be explained in detail.

Basically, the filter 100 includes trapping means 132 of a plurality of filter granules stacked to a predetermined volume, and holding means 130 for holding the filter granules in a required form.

Referring to FIG. 1, the filter 100 is substantially cylindrical, and arranged parallel to a flow direction of the exhaust gas substantially, to facilitate a shorter filter length that makes reduction of a total volume of the filter easy. Of course, the filter 100 may be cylindrical, but arranged perpendicular to a flow direction of the exhaust gas substantially.

Next, the filter granules in the trapping means 132 will be explained.

The higher the filtering efficiency, and the greater the filtering capacity, the filter is the better. Therefore, it is required that the filter granule is selected both in view of the filtering efficiency, and the filtering capacity.

In the meantime, the larger the surface area of filter granules per a unit volume of the filter (a total surface area of the filter granules/a filter volume, hereafter called as “specific surface area of the filter granule”), a probability of the soot deposition is increased, to increase the filtering efficiency.

Moreover, the greater the pore ratio, the smaller the pressure loss before and after the filter, and the greater the filtering capacity. The filtering efficiency and the filtering capacity are one of the most important factors in filter performances that filtering the exhaust gas from a car.

The PCT/KR10/00112 suggests a filter mostly having substantially spherical or oval filter granules of a size stacked therein. Ceramic, or metal granules may be formed by an electro-chemical method, a physical method, or a mechanical method, whereas the filter granules employed in the granule layer filter are formed by the mechanical method, mostly.

Because, in the electro-chemical method, a gas, or a liquidus raw material, or an electrolyte solution containing a raw material, is subjected to electrolysis, or chemical reaction, to form the ceramic or the metal granules, directly. However, the electro-chemical method is suitable for formation of very small sized granules below a few tens of micrometers, mostly, but difficult to apply to formation of the filter granules of comparatively large sizes larger than one hundred micrometers.

In the physical method, mostly employed in formation of metallic powder having a low melting point and a vaporizing temperature, a lump metal is heated to melt or vaporize, sprayed or sputtered, and solidified. Though this method permits to form comparatively uniform forms and sizes of granules, this method consumes much energy. Particularly, since the granules for the soot trapping filter require to be of a heat resistant material that can endure even a high temperature, with a high melting point and vaporizing temperature, the physical method is not practicable.

In the mechanical methods, a traditional method in which a lump of metal or ceramic is given mechanical impacts into fine granules, there are mechanical cutting, breakage, and grinding. Though those methods cost low, control of granule sizes and forms are difficult. For obtaining spherical or oval granules, it is required that granules formed by a mechanical method (hereafter called as “chip”) are mechanically re-processed, by using abrasion, mostly. That is, the chips are subjected to abrasion to one another, for controlling detailed sizes and forms, to form spherical or oval granules. This abrasion process takes the longest time, and has the poorest energy efficiency, of mechanical granule formation processes.

However, the inventor becomes to find out that the filtering efficiency and the filtering capacity can be improved even by using the chips before the abrasion process as they are, which will be explained later. If the filtering efficiency is equal to, or higher than the spherical granule even if the chip before the abrasion process is thus used, the use of the chip before the abrasion process has very significant advantages in that a filtering efficiency equal to, or higher than the related art can be obtained while temporal and economic costs can be reduced effectively because the abrasion process can be omitted from the chip formation.

The reason that the use of chip before the abrasion process can improve the filtering efficiency and the filtering capacity will be explained.

Though it is difficult to see with naked eyes as the filter granules are of sizes greater than a few hundred micrometers, the granules before the abrasion process, i.e., the chips are not spherical or oval, but irregular polyhedrons. Meanwhile, since the irregular granule has a specific surface area greater than the spherical or oval granule, the filtering efficiency is improved, thereby improving a filter performance, actually.

Of course, the polyhedral filter granule employed in the present invention is not limited to the granule before the abrasion process, but any granule of polyhedral form or non circular section can be used.

The fact that a polyhedral granule has a specific area larger than a spherical granule will be explained with reference to FIG. 2. It is assumed that “L” denotes a circumferential length of a regular polygon with unit area, and “N” denotes a number of apexes of the regular polygon. When “N” approaches to infinite, the polygon approaches to a circle, and “L” and “N” has the following relation.

L∝2{N tan(π/N)}^{1/2}, where π denotes a number π.

As can be noted in the equation and FIG. 2, the greater the “N”, the smaller the circumferential length. Of polygons with the same areas each having N apexes, a regular polygon has the shortest circumferential length. Accordingly, a regular polygon has a circumference greater than a circle, and a non-regular polygon has a circumference greater than a regular polygon. This can be similarly applicable to a granule, and, if there is no condition that the granule is convex, a polyhedron can have a specific surface area significantly larger than a sphere.

Therefore, the employment of non-spherical filter granules, i.e., polyhedral filter granules increases the specific surface area for a filter with the same total filter volume, with an increased filtering efficiency. That is, it is preferable that the filter granule employed in the filter has an irregular section. Or, substantially circular section filter granules and polyhedral filter granules may be mixed at a predetermined ratio.

Of course, the filter granules in the filter may consist of a mixture of polyhedral granules different from one another with respect to one or more of material, shape, and size within predetermined ranges.

Meantime, it is preferable that the filter granule is formed of a metal or ceramic containing silicon carbide. Because, even if the silicon carbide is a ceramic, the silicon carbide has a heat conductivity higher than a general metal, which is very desirable in view of enhancing an endurance of the filter since it makes dissipation of heat faster, with a subsequent smaller temperature gradient in the filer, when the trapped soot is incinerated, i.e., when the filter is regenerateed.

Moreover, it is preferable that the filter granules are coated with a predetermined catalyst. Of usable catalysts, there are a catalyst that assists an appropriate disposal of pollutant refuse other than the granular substance, a catalyst that assists oxidation of the soot stuck to the filter granules, and the like. Of course, the present invention has no limitation of the catalysts.

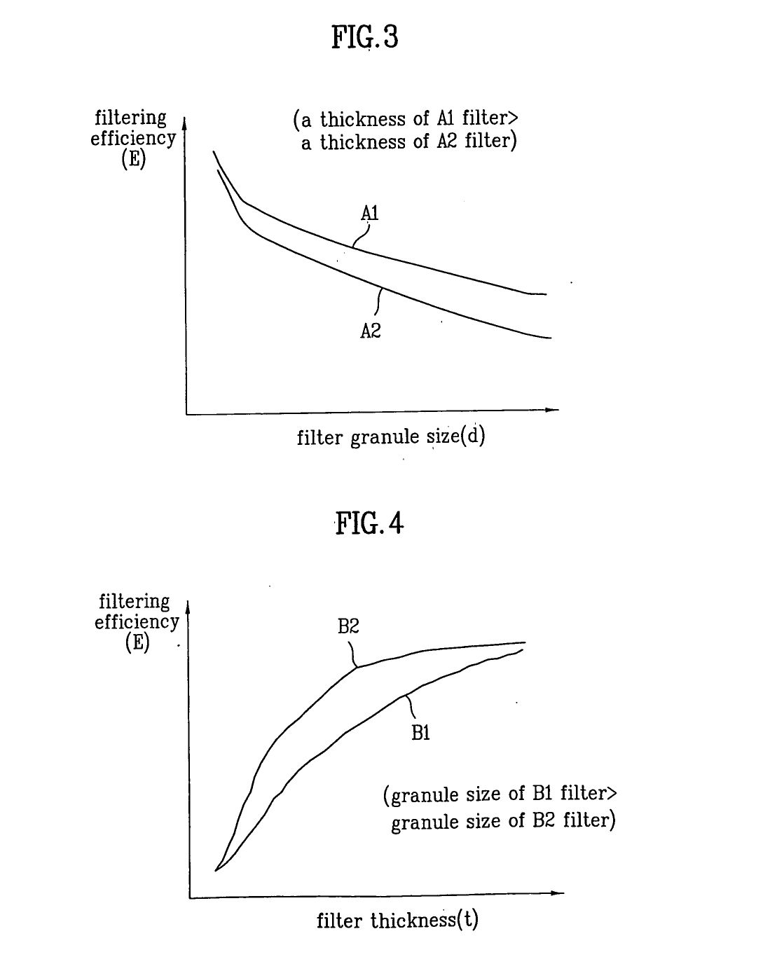

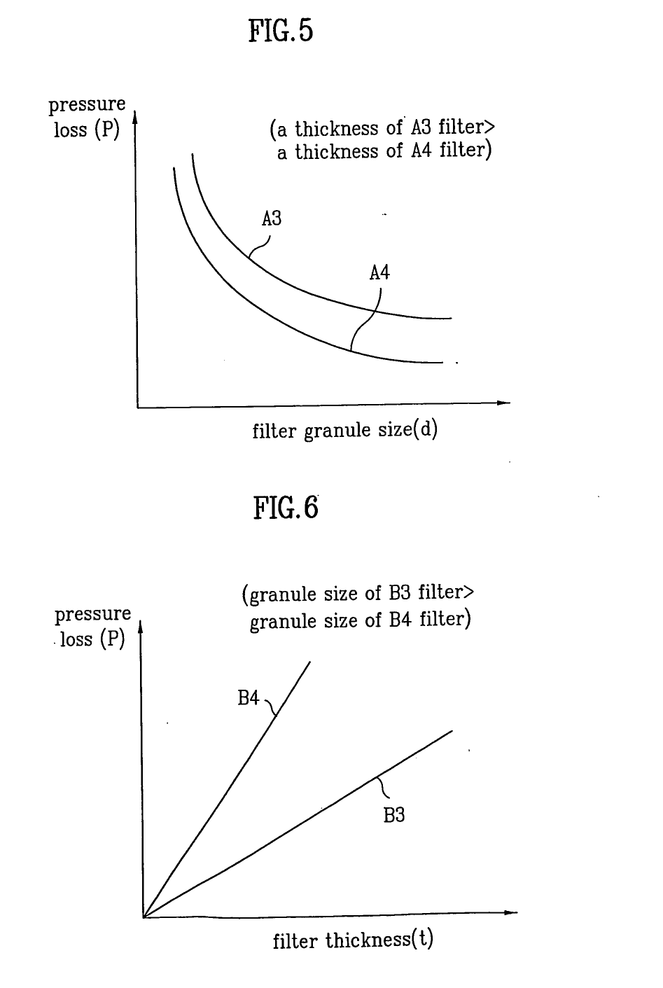

Next, a filter thickness, and a granule size will be discussed with reference to FIGS. 3-6.

The smaller the filter granules, and the greater the filter thickness, i.e., the thickness of the granule layer in the trapping means, the filtering efficiency increases exponentially, because the smaller the filter granules, or the greater the filter thickness, the larger the filtering surface area. That is, the smaller the granule size, the larger the surface area per unit filter volume (specific surface area), and the greater the filter thickness, the larger the total filtering surface area as the filter volume is increased.

Therefore, the smaller the granule size, and the thicker the filter thickness, the more favorable in view of the filtering efficiency. In another aspect, for having the same filtering efficiency, it is required that the filter thickness becomes the greater as the granule size in the filter becomes the greater, and those two can not be set independently.

In this instance, for filters with the same efficiencies, a filter with greater granule size and greater filter thickness has a greater filtering capacity and a smaller pressure loss than a filter of an opposite case.

However, though favorable for the filtering capacity and the pressure loss, an excessively great granule size, with consequential great filter thickness and a filter volume, increases volume and weight of an apparatus. Therefore, it is required that an appropriate granule size and filter thickness are set taking the filtering efficiency and the filtering capacity (or a regenerating period).

Since the soot trapping filter of the present invention is characterized of being a volumetric filtering type in which the filter has a thickness greater than a predetermined size, and filtering is carried out in whole filter granule layer in the filter, it is preferable that a total thickness ‘t’ of the filter is set to be greater than 15 mm, and preferably with a filter granule size in a range of 500 μm-1500 μm.

Moreover, if the filter has multiple stages, it is preferable that the filter granule size becomes the smaller as it goes from a front stage filter 110 to a rear stage filter 120. As shown in FIG. 1, if the filter has two stages, it is preferable that a front stage filter has a thickness ‘t1’ greater than 5 mm and a filter granule size in a range of 500 μm -1500 μm, and a rear stage filter has a thickness ‘t2’ greater than 10 mm and a filter granule size in a range of 100 μm -500 μm.

Furthermore, it is preferable that the granule layer is formed of a single sized granules or a mixture of filter granules of different sizes mixed at a predetermined ratio, preferably with a pore ratio thereof being in a range of 35%-50%.

In the meantime, a proper thickness of the trapping means may be defined by a ratio of a total filter volume to an inlet surface area.

Next, the filter will be discussed in view of the pore ratio.

The pore ratio will be in a range of 25%-40% depending on stacking methods when spherical filter granules of substantially identical sizes are stacked. Contrary to this, the pore ratio is approx. 43% as a result of experiment in which the granule layer is formed of polyhedral chips with sizes ranging 200 μm-350 μm; a slight improvement compared to a case the spherical granules are employed.

However, the pore ratio of the granule layer varies with a granule shape and a size distribution, which is very difficult to analyze mathematically. In general, the more uniform the granule size, the greater the pore ratio, the more different in the sizes of mixture of the granules, the smaller the pore ratio. This is because smaller granules stuff pores formed by greater granules, if smaller and greater granules are mixed. Moreover, the granule layer formed of an appropriate mixture of non-convex polyhedrons has a pore ratio greater than the granule layer formed only of convex polyhedrons.

### INDUSTRIAL APPLICABILITY

The advantages of the soot trapping filter, and the soot reducing device thereof of the present invention will be explained.

First, the employment of irregular polyhedrons as filter granules provides a larger specific surface area and a greater pore ratio in comparison to the related art granular filtering materials, thereby improving a filtering efficiency and a filtering capacity. That is, the filter of the present invention improves the filtering efficiency and the filtering capacity even if a volume of the filter of the present invention is the same with the filter suggested in the PCT/KR10/00112.

Second, though the related art spherical filter granules have one inter-filter granule contact point, the polyhedral filter granules have one or more than one inter-filter granule contact point. Therefore, the filter of the present invention has an inter-filter granule contact surface larger than the related art when spherical filter granules are employed, that increases an effective heat transfer coefficient, to make more uniform temperature distribution in the filter when a rapid temperature change is occurred by a regenerating, and the like.

Third, the employment of irregular polyhedron filter granules reduces a production cost, and time substantially in comparison to the related art spherical granules, that is favorable in view of economy.

Fourth, the filter of the present invention still has the advantages of the related art spherical granule filter; a good thermal endurance, a good mechanical endurance, and a freedom in designing a form of the filter.

What is claimed is:

1. A soot trapping filter comprising:
trapping means having a plurality of filter granules stacked to form a volume, for trapping soot contained in exhaust gas from a combustion apparatus at a whole volume of the trapping means, wherein the filter granules include a ratio of non-spherical filter granules higher than a predetermined ratio.

2. A soot trapping filter as claimed in claim 1, wherein the non-spherical filter granule is polyhedral.

3. A soot trapping filter as claimed in claim 2, wherein the non-spherical filter granule has an irregular polygonal section.

4. A soot trapping filter as claimed in claim 2, wherein the polyhedral filter granule has an average size ranging 100 μm-1500 μm.

5. A soot trapping filter as claimed in claim 2, wherein the trapping means has a pore ratio ranging 35%-50%.

6. A soot trapping filter as claimed in claim 2, wherein the polyhedral filter granule is formed of at least one combination of ceramics or metals including silicon carbide.

7. A soot trapping filter as claimed in claim 2, wherein the filter granule includes a catalyst coated thereon suitable for processing pollutant refuse other than granular material.

8. A soot trapping filter as claimed in claim 2, wherein the filter granule includes a predetermined catalyst coated thereon for accelerating oxidation of the soot trapped at the filter granule.

9. A soot trapping filter as claimed in one of claims 1 to 8, wherein the trapping means has a thickness greater than 15 mm.

10. A soot trapping filter as claimed in claim 2, wherein the trapping means is substantially cylindrical, and an exhaust gas flow direction and a direction of the exhaust gas entering into the trapping means are substantially vertical.

11. A soot trapping filter as claimed in claim 2 or 10, wherein the trapping means includes multiple stages of granule layers.

12. A soot trapping filter as claimed in claim 11, wherein the filter granules in the multiple stages of granule layers differ in at least one of material, shape, and size.

13. A soot trapping filter as claimed in claim 11, wherein the filter granules in the multiple stages of granule layers have an average size becoming gradually the smaller as it goes from a front stage granule layer to a rear stage granule layer.

14. A soot reducing device comprising:
a filter fitted on a predetermined position of an exhaust gas passage having trapping means with a plurality of filter granules stacked to form a volume; and
heating means fitted in or at an interface of the filter, for elevating a temperature of the exhaust gas introduced thereto.

15. A soot reducing device as claimed in claim 14, further comprising a diffuser in a front stage of the filter for making the exhaust gas flow uniform.
